(19) United States
(12) Patent Application Publication
(10) Pub. No.: US 2016/0230070 A1
(43) Pub. Date: Aug. 11, 2016

(54) INVERT EMULSION DRILLING FLUIDS WITH FUMED SILICA AND METHODS OF DRILLING BOREHOLES

(71) Applicant: Halliburton Energy Services, Inc., Houston, TX (US)

(72) Inventors: Vikrant Bhavanishankar Wagle, Mumbai (IN); Dhanashree Gajanan Kulkarni, Pune (IN); Shadaab Syed Maghrabi, Thane (IN)

(73) Assignee: Halliburton Energy Services, Inc., Houston, TX (US)

(21) Appl. No.: 14/913,938

(22) PCT Filed: Sep. 24, 2013
(86) PCT No.: PCT/US2013/061620

§ 371 Date: Feb. 23, 2016

(51) Int. Cl. C09K 8/36; E21B 21/00; E21B 7/00

(52) U.S. Cl. CPC C09K 8/36; E21B 7/00; E21B 21/00

(57) ABSTRACT

An invert emulsion drilling fluid employing as a suspension agent very fine sized fumed silica in combination with a primary viscosifier such as for example a fatty dimer diamine, and a method for the use thereof in drilling wellbores, with good rheological properties at high temperatures and pressures. In one embodiment the drilling fluid is free of organophilic clays and lignites and free of non-hydrophilic “low gravity solids,” and the fumed silica is a hydrophilic fumed silica, which provides enhanced suspension of drill cuttings without barite sag while maintaining good rheological properties at high temperatures and pressures.

### BACKGROUND

1. Field of the Disclosure

The present disclosure relates to compositions and methods for drilling, cementing and casing boreholes in subterranean formations, particularly hydrocarbon bearing formations. More particularly, the present disclosure relates to oil or synthetic fluid based invert emulsion drilling fluids which combine high ecological compatibility with good stability and performance properties. Most particularly, the disclosure relates to “clay-free” invert emulsion drilling fluids.

2. Description of Relevant Art

A drilling fluid or mud is a specially designed fluid that is circulated through a wellbore as the wellbore is being drilled to facilitate the drilling operation. The various functions of a drilling fluid include removing drill cuttings from the wellbore, cooling and lubricating the drill bit, aiding in support of the drill pipe and drill bit, and providing a hydrostatic head to maintain the integrity of the wellbore walls and prevent well blowouts. Specific drilling fluid systems are selected to optimize a drilling operation in accordance with the characteristics of a particular geological formation.

Oil or synthetic fluid-based muds are normally used to drill swelling or sloughing shales, salt, gypsum, anhydrite or other evaporate formations, hydrogen sulfide-containing formations, and hot (greater than about 300 degrees Fahrenheit (“° F.”)) holes, but may be used in other holes penetrating a subterranean formation as well. Unless indicated otherwise, the terms “oil mud” or “oil-based mud or drilling fluid” shall be understood to include synthetic oils or other synthetic fluids as well as natural or traditional oils, and such oils shall be understood to comprise invert emulsions.

Oil-based muds used in drilling typically comprise: a base oil (or synthetic fluid) comprising the external phase of an invert emulsion; a saline, aqueous solution (typically a solution comprising about 30% calcium chloride) comprising the internal phase of the invert emulsion; emulsifiers at the interface of the internal and external phases; and other agents or additives for suspension, weight or density, oil-wetting, fluid loss or filtration control, and rheology control. Such additives commonly include organophilic clays and organophilic lignites. An oil-based or invert emulsion-based drilling fluid may commonly comprise between about 50:50 to about 95:5 by volume oil or oleaginous phase to water or aqueous phase.

Recent technology as described for example in U.S. Pat. Nos. 7,462,580 and 7,488,704 to Kirsner, et al., introduced “clay-free” invert emulsion-based drilling fluids, which offer significant advantages over drilling fluids containing organophilic clays. As used herein, the term “clay-free” (or “clayless”) means a drilling fluid made without addition of any organophilic clays or lignites to the drilling fluid composition.

When used in drilling, “clay-free” invert emulsion drilling fluids have shown reduced downhole losses, reduced pressure surges and spikes, and less barite sag than traditional drilling fluids containing organophilic clay and lignites. Hole drilling is faster with “clay-free” invert emulsion drilling fluids and reservoir productivity is often greater.

Upon reuse or mixing with recycled fluids, “clay-free” invert emulsion fluids often need additives to bolster the rheological properties and particularly the suspension character of the system. Prior art has indicated that without addition of low gravity solids, such as sized calcium carbonate which is not hydrophilic, or similarly non-hydrophilic clay type materials having a specific gravity of about 2.2 to about 2.7, aging of “clay-free” invert emulsion drilling fluids through reuse can result in loss of suspension characteristics and eventually barite sag. In turn, barite sag can result in fracturing of the formation and drilling fluid losses in the fractures. However, in the prior art, addition of low gravity solids to a “clay-free” invert emulsion drilling fluid takes away from the advantages the fluid offers by being “clay-free.” Thus, the addition of such low gravity solids has been preferably kept to a minimum in the prior art.

As used herein, “low gravity solids” does not refer to drill cuttings or drill solids, which typically contain clay and/or silica, even if those solids have a specific gravity in the range of about 2.2 to about 2.7, and even though drill cuttings and drill solids may enter and become part of the fluid during drilling. As used herein, “low gravity solids” refers to solid materials (other than silica) such as sized calcium carbonate, ground marble, or clay materials such as zeogel, bentonite, attapulgite, and the like that are non-hydrophilic and that are deliberately and purposefully added to drilling fluids in preparing the drilling fluid composition or during drilling to alter the drilling fluid composition. Thus, the term “low gravity solids” as used herein may also be considered to be “low gravity solid additives” or “additives comprising low gravity solids.”

Invert emulsion-based muds or drilling fluids (also called invert drilling muds or invert muds or fluids) comprise a key segment of the drilling fluids industry, but they are increasingly being subjected to greater environmental restrictions and performance and cost demands. The complexities and unpredictability of the interaction and behavior of the fluid components with each other and with the conditions encountered during drilling make meeting these demands challenging.

There is a continuing need and thus ongoing industry-wide interest in new drilling fluids that provide improved performance while still affording environmental and economical acceptance. And there is a continuing interest and desire for “clay-free” invert emulsion drilling fluids, that are free of low gravity solids such as calcium carbonate or organophilic clays and clay type solids, but that may be reused and still be free from barite sag.

### SUMMARY

The present disclosure provides an invert emulsion drilling fluid, and a method for the use thereof in drilling wellbores. The drilling fluid of the disclosure comprises a viscosifier, such as a dimer fatty acid, or dimer fatty amine, or a pentaerythritol tetrasterarate, and very fine sized fumed silica, which impart to the fluid improved suspension properties sufficient to avoid barite sag without loss of rheological properties. The fumed silica used in the disclosure has a high surface area and low particle size and in one embodiment is hydrophilic. In one embodiment, the drilling fluid is also “clay-free,” that is, it is made without addition of any organophilic clays or lignites to the drilling fluid composition.

As used herein, the term “drilling” or “drilling wellbores” shall be understood in the broader sense of drilling operations, which includes running casing and cementing as well as drilling, unless specifically indicated otherwise. The method of the disclosure comprises using the drilling fluid of the disclosure in drilling wellbores. During drilling, the drilling fluid is not dependent on organophilic clays (also called “organo-clays”) to obtain suspension of drill cuttings or other solids at rest, and lacks a significant (if any) pressure spike upon resumption of drilling, after a period when drilling has temporarily ceased during the drilling operation.

In addition to providing the advantages of an organophilic “clay-free” system, the drilling fluid of the disclosure shows high pressure, high temperature (HTHP) stability. While some organophilic clay may enter the fluid in the field, for example, due to mixing of recycled fluids with the fluid of the disclosure, the fluid of the disclosure is tolerant of such clay in insubstantial quantities, that is, in quantities less than about three pounds per barrel. The fluid of the disclosure, however, behaves more like a traditional drilling fluid when more than about three pounds per barrel of organo-clays are present. Similarly, the fluid of the disclosure is tolerant of calcium carbonate and other non-hydrophilic “low gravity solids” that may enter the fluid in insubstantial quantities.

### BRIEF DESCRIPTION OF THE DRAWINGS

FIG. 1 is a graph showing fragile gel formation with one embodiment of an invert emulsion drilling fluid of the disclosure (Fluid 3 in Table 1) after hot rolling at 250° F.

FIG. 2 is a graph showing fragile gel formation in another embodiment of an invert emulsion drilling fluid of the disclosure (Fluid 1 in Table 3) after hot rolling at 300° F.

FIG. 3 is a diagram of a typical drilling fluid system in which the invert emulsion drilling fluids of the disclosure may be used.

### DETAILED DESCRIPTION OF SOME EMBODIMENTS

In one embodiment, the present disclosure provides an invert emulsion drilling fluid that meets environmental constraints and provides improved performance in the field with the lack of barite sag, even at high temperatures and pressures and even after aging. In this or another embodiment, the invert emulsion drilling fluids of the present disclosure are “clayless” or “clay-free,” meaning that they are made without the addition of organophilic clays or lignites.

The invert emulsion drilling fluids for use in one embodiment of the present disclosure are mineral oil based systems or mineral oil/paraffin based systems, such as, for example, the INNOVERT® invert emulsion fluid system, which has a paraffin and/or mineral oil base and is available from Baroid Fluid Services, a Halliburton Company, in Houston, Tex. and Duncan, Okla. An example of a commercially available base oil for use in the disclosure is ESCAID® 110 desulfurized hydrogenated kerosene oil base from ExxonMobil, USA in Houston, Tex. and ExxonMobil Chemical Company in Houston, Tex. These base oils are environmentally acceptable but other base oils, natural or synthetic, may be used in other embodiments. The internal phase of the invert emulsion drilling fluids of the present disclosure typically comprises an aqueous fluid.

The invert emulsion drilling fluids of the present disclosure contain a suspension agent comprising a primary viscosifier such as: a dimer fatty acid, for example, commercially available RHEMOD L™ additive having 36 carbons; a dimer fatty amine, for example, commercially available BDF 570™ additive having 36 carbons; or a pentaerythritol tetrastearate, for example, commercially available BDF 489™ additive. Each of these commercially available products may be obtained from Halliburton Energy Services, Inc. in Houston, Tex. and Duncan, Okla. Hydrophobic amines such as VERSAMINE® 552 hydrogenated fatty C36 dimer diamine and VERSAMINE®551 fatty C36 dimer diamine, both available from Cognis Corporation of Monheim, Germany and Cincinnati, Ohio, may also be alternatively used as a primary viscosifier for invert emulsion drilling fluids of this disclosure. Other fatty dimer diamines suitable for use in the invert emulsion drilling fluids of the present disclosure include C28 fatty dimer diamines to C48 fatty dimer diamines which are prepared via dimerization of the relevant C14 to C24 fatty acids. Typically, an amount of such viscosifier in the range of about 1 pound per barrel (ppb) to about 3 ppb is sufficient for purposes of the invert emulsion drilling fluids of the disclosure.

The invert emulsion drilling fluids of the present disclosure further contain very fine sized fumed silica as a suspension agent. For purposes of the invert emulsion drilling fluids of this disclosure, this fumed silica should have a high surface area, preferably at least 90 m²/g and most preferably greater than about 90 m²/gm up to about 700 m²/gm. In one embodiment of the disclosure, the primary viscosifier is used with the very fine sized fumed silica as a suspension agent in a ratio of about 1 to about 5 or in a range of about 0.5 ppb to about 3 ppb of primary viscosifier to about 0.5 ppb to about 15 ppb very fine sized fumed silica. In another embodiment, two different grades of silica are used, one with a higher surface area than the other, such as, one with an average particle size of 7 nm or a specific surface area of 380 m²/gm 380—for example, AEROSIL® 380 hydrophilic fumed silica available from Evonik Industries in Germany, Singapore, Japan, and Parsippany, N.J. in the United States—and one with an average particle size of 0.1-0.3 μm or a surface area of 17-30 m²/gm—for example, SILICA FUME hydrophilic fumed silica, available from Norchem, Inc. in Hauppage, N.Y. and Fort Pierce, Fla. Generally, the lower the surface area of the fumed silica the more fumed silica will be needed. Fumed silica having a surface area less than 90 m²/gm may require too high of a concentration to be effective in the invert emulsion drilling fluids of this disclosure. While hydrophobic fumed silica is also available, hydrophilic fumed silica is preferred for the present disclosure, even though low gravity solids traditionally or commonly used in the prior art are not hydrophilic and are often hydrophobic and even though hydrophilic fumed silica may enter the internal phase of the invert emulsion.

Silica is listed in the PLONOR list of additives that can be used in the North Sea. It is thus environmentally compatible or “eco-friendly.” Silica is also thermally very stable and thus is reliable for use under high temperature, high pressure (HTHP) conditions, as those conditions are commonly understood to one of ordinary skill in the art.

Other additives to comprise a complete drilling fluid may also be used in the invert emulsion drilling fluids of the present disclosure so long as the additives do not include organophilic clays or lignites. Typical additives suitable for use in drilling fluids of the present disclosure include, for example: additives to reduce or control temperature rheology or to provide thinning, for example, additives having the tradenames COLDTROL®, ATC®, and OMC2™; additives for enhancing viscosity, for example, an additive having the tradename RHEMOD L™; additives for providing temporary increased viscosity for shipping (transport to the well site) and for use in sweeps, for example, an additive having the tradename TEMPERUS™ (modified fatty acid); additives for filtration control, for example, additives having the tradename ADAPTA®; additives for high temperature high pressure control (HTHP) and emulsion stability, for example, additives having the tradename FACTANT™ (highly concentrated tall oil derivative); and additives for emulsification, for example, additives having the tradename LE SUPERMUL™ (polyaminated fatty acid) or emulsifier activators like lime. All of the aforementioned trademarked products are available from Halliburton Energy Services, Inc. in Houston, Tex., U.S.A. and Duncan Okla., U.S.A. The exact formulations of the invert emulsion drilling fluids of the disclosure vary with the particular requirements of the subterranean formation.

When compared to invert emulsion drilling fluids commonly used, and when making such comparisons after aging or recycling, the invert emulsion drilling fluids of the present disclosure advantageously afford superior suspension properties and avoid barite sag while they are simultaneously environmentally compatible or “eco-friendly.”

Example formulations of invert emulsion drilling fluids of the disclosure and results of laboratory tests with same are set forth below to demonstrate the effectiveness of these fluids.

### Experiments

Except where noted otherwise, all products in Table 1 are available from Halliburton Energy Services, Inc. in Houston, Tex. and Duncan Okla., including:

ADAPTA® crosslinked copolymer for HTHP filtration control;
BAROID® weighting agent, which is ground barium sulfate;
BDF™ 570 dimer diamine rheology modifier.
EZ MUL® NT emulsifier, which is a polyaminated fatty acid;
RHEMOD™ viscosifier, which is a modified fatty acid that is used to provide suspension and viscosity in non-aqueous drilling fluids;
and
ESCAID® 110 oil, which is a desulfurized hydrogenated kerosene low toxicity oil containing less than 0.1% sulfur and less than 1% aromatics, and which is available from ExxonMobil Company, U.S.A., Houston, Tex., and ExxonMobil Chemical Company, Houston, Tex.

Table 1 provides various formulations of “clay-free” invert emulsion drilling fluids prepared with ESCAID® 110 oil base (comprising desulfurized hydrogenated kerosene—C₁₁-C₁₄ hydrocarbons: n-alkanes, isoalkanes, cyclics, <2% aromatics), and an aqueous internal phase. Fluid 1 in Table 1 is a “control” prepared according to prior art drilling fluids, that is, an invert emulsion drilling fluid prepared with ESCAID® base oil and an aqueous internal phase, with a commercially available primary viscosifier (RHEMOD™ L viscosifier), but without any organophilic clays or lignites and without any “low gravity solids.” Fluid 2 in Table 1 has the same formulation as Fluid 1 except that Fluid 2 includes a commercially available very fine sized hydrophilic fumed silica, AEROSIL® 380 fumed silica, having a specific gravity of 2.2, instead of the primary viscosifier, RHEMOD™ L. Fluid 3 has an example formulation of a fluid of the disclosure, having the components of Fluid 1 but also including AEROSIL® 380 fumed silica as a suspension agent, (as well as or in combination with the primary viscosifier, RHEMOD™ L). These 12 ppg LGS-free fluids were hot rolled at the desired temperature, viz. 250° F. in this experiment, followed by testing for rheological and suspension characteristics.

The rheological characteristics of Yield Point (YP) and Plastic Viscosity (PV) of the invert emulsion drilling fluid were determined on a direct-indicating rheometer, a FANN 35 rheometer, powered by an electric motor. The rheometer consists of two concentric cylinders, the inner cylinder is called a bob, while the outer cylinder is called a rotor sleeve. The drilling fluid sample is placed in a thermostatically controlled cup and the temperature of the fluid is adjusted to 120 (±2° F. The drilling fluid in the thermostatically controlled cup is then placed in the annular space between the two concentric cylinders of the FANN 35. The outer cylinder or rotor sleeve is driven at a constant rotational velocity. The rotation of the rotor sleeve in the fluid produces a torque on the inner cylinder or bob. A torsion spring restrains the movement of the bob, and a dial attached to the bob indicates displacement of the bob. The dial readings are measured at different rotor sleeve speeds of 3, 6, 100, 200, 300 and 600 revolutions per minute (rpm). Generally, Yield Point (YP) is defined as the value obtained from the Bingham-Plastic rheological model when extrapolated to a shear rate of zero. It may be calculated using 300 rpm and 600 rpm shear rate readings as noted above on a standard oilfield rheometer, such as a FANN 35 or a FANN 75 rheometer. Similarly, Yield Stress or Tau zero is the stress that must be applied to a material to make it begin to flow (or yield), and may commonly be calculated from rheometer readings measured at rates of 3, 6, 100, 200, 300 and 600 rpm. The extrapolation may be performed by applying a least-squares fit or curve fit to the Herchel-Bulkley rheological model. A more convenient means of estimating the Yield Stress is by calculating the Low-Shear Yield Point (LSYP) by the formula shown below in Equation 2 except with the 6 rpm and 3 rpm readings substituted for the 600-rpm and 300-rpm readings, respectively. Plastic Viscosity (PV) is obtained from the Bingham-Plastic rheological model and represents the viscosity of a fluid when extrapolated to infinite shear rate. The PV is obtained from the 600 rpm and the 300 rpm readings as given below in Equation 1. A low PV may indicate that a fluid is capable of being used in rapid drilling because, among other things, the fluid has low viscosity upon exiting the drill bit and has an increased flow rate. A high PV may be caused by a viscous base fluid, excess colloidal solids, or both. The PV and YP are calculated by the following set of equations:

PV=(600 rpm reading)−(300 rpm reading) (Equation 1)

YP=(300 rpm reading)−PV (Equation 2)

More particularly, each of the experiments or tests were conducted in accordance with standard procedures set forth in Recommended Practice 13B-2, Recommended Practice for Field Testing of Oil-based Drilling Fluids, Fourth Edition, American Petroleum Institute, Mar. 1, 2005, known to those of ordinary skill in the art.

The suspension characteristics were determined by calculating the sag factors according to the following procedure. Generally, only drilling fluids and related treatment fluids that are considered “stable” after performing stability testing are tested for the “sag factor” (SF). The fluid to be tested for “sag factor” is placed into a high-temperature, high-pressure aging cell. The fluid is then static aged at a specified temperature for a specified period of time. The specific gravity (SG) of the fluid is measured at the top of the fluid and at the bottom part of the fluid in the aging cell. The sag factor is calculated using the following formula: SF=SGbottom/(SGbottom+SGtop). A sag factor of greater than 0.53 indicates that the fluid has a potential to sag; therefore, a sag factor of less than or equal to 0.53 is considered to be a good sag factor.

For a drilling fluid to exhibit acceptable suspension characteristics for use as a drilling fluid and to avoid barite sag, the sag factor should be between 0.50 and 0.53, which allows for some expected and unavoidable settling of solids. A drilling fluid which has a sag factor of greater than 0.53 is considered to have inadequate suspension properties and as stated above implies that the fluid has potential to sag.

Thus, Table 1 below provides an example formulation and properties for a “clay-free,” “low-gravity-solids”-free, invert emulsion drilling fluid of the disclosure (Fluid 3 in Table 1) and compares it to the “control,” a “clay-free,” “low-gravity-solids”-free invert emulsion drilling fluid with a primary viscosifier and without very fine sized fumed silica (Fluid 1 in Table 1), and to a formulation using very fine sized fumed silica as a suspension agent without the primary viscosifier (Fluid 2 in Table 1). Table 2 provides an example formulation (Fluid 4 in Table 2) and properties for a “clay-free,” “low-gravity-solids”-free, invert emulsion drilling fluid with a primary viscosifier and a silica fume commonly used in cement and different from the fumed silica used in the invert emulsion drilling fluids of this disclosure, with a lower surface area than the fumed silica used in the example formulation of the invert emulsion drilling fluids of this disclosure set forth in Table 1. Table 3 provides another (different) example formulation (Fluid 5 in Table 3) and properties for a “clay-free,” “low-gravity-solids”-free invert emulsion drilling fluid of the disclosure hot rolled at a temperature of 300° F. instead of at 250° F. This formulation is similar to that of Fluid 3 in Table 1, except that this formulation (Fluid 5) in Table 3 also includes a dimer diamine rheology modifier.

In determining the properties set forth in the tables, samples of the fluids were formulated and sheared at 11,000 rpm to 12,000 rpm on a multimixer for the times and concentrations indicated in the tables, and then rolled at 250° F. or 300° F. as indicated for 16 hours, and then static aged for 24 hours at 250° F. or 300° F. Measurements were taken with the fluids at 120° F., except where indicated otherwise. Measurements of SAG factor and oil separation as well as rheological properties were taken. Brookfield viscosity measurements for fragile gels were also taken.

TABLE 1
12 ppg 70/30 OWR Base

| | | Formulation No. | | | | | | |
|---|---|---|---|---|---|---|---|---|
| | | 1 | | 2 | | 3 | | 3 |
| ESCAID ® | | 150.34 | Fluid | 151.23 | Fluid | 148.84 | Fluid | Fluid 3 |
| 110, bbl | | | 1 was | | 2 was | | 3 was | was |
| EZ MUL ® NT, | 2 | 10.00 | static | 10.00 | static | 10.00 | static | static |
| ppb | | | aged @ | | aged @ | | aged @ | aged @ |
| Lime, ppb | 2 | 1.50 | 250° F. | 1.50 | 250° F. | 1.50 | 250° F. | 150° F. |
| RHEMOD ™ | 5 | 3.00 | 24 hrs | 0.00 | 24 hrs | 3.00 | 24 hrs | 120 hrs |
| L, ppb | | | | | | | | |
| ADAPTA ®, | 5 | 2.00 | | 2.00 | | 2.00 | | |
| ppb | | | | | | | | |
| AEROSIL ® | 5 | 0.00 | | 10.00 | | 10.00 | | |
| 380, ppb | | | | | | | | |
| CaCl₂, ppb | | 29.60 | | 29.30 | | 29.30 | | |
| Water, ppb | 5 | 85.30 | | 84.50 | | 84.50 | | |
| BAROID ®, | 10 | 222.2 | | 215.40 | | 221.74 | | |
| ppb | | | | | | | | |
| Hot rolled at | | | | | | | | |
| 250° F., 16 hrs | | | | | | | | |
| 600 rpm | | 37 | 34 | 46 | 46 | 81 | 82 | |
| 300 rpm | | 23 | 20 | 24 | 24 | 49 | 50 | |
| 200 rpm | | 18 | 15 | 14 | 15 | 38 | 39 | |
| 100 rpm | | 12 | 10 | 8 | 8 | 25 | 25 | |
| 6 rpm | | 4 | 3 | 1 | 1 | 7 | 9 | |
| 3 rpm | | 3 | 2 | 1 | 1 | 6 | 9 | |
| PV | | 14 | 14 | 22 | 22 | 32 | 32 | |
| YP | | 9 | 6 | 1 | 2 | 17 | 18 | |
| LSYP | | 2 | 1 | 1 | 1 | 5 | 9 | |
| GELS 10 sec | | 5 | 3 | 1 | 1 | 6 | 8 | |
| GELS 10 min | | 5 | 4 | 1 | 1 | 58 | 50 | |
| HTHP, | | | | | | | | |
| ml/30 min | | | | | | | | |
| (250° F.) | | | | | | | | |
| Sag factor | | | 0.68 | | 0.68 | | 0.50 | 0.5 |
| Oil separation | | | 8 cm/ | | 7 cm/ | | 0.2 cm | 0.2 cm |
| | | | 100 ml | | 95 ml | | | |

TABLE 2

| | Mixing | | |
|---|---|---|---|
| | time, min | 4 | |
| ESCAID ® 110, bbl | | 150.34 | Fluid 4 |
| EZ MUL ® NT, ppb | 2 | 10.00 | was |
| Lime, ppb | 2 | 1.50 | static aged |
| RHEMOD ™ L, ppb | 5 | 3.00 | @ 250° F. |
| ADAPTA ®, ppb | 5 | 2.00 | 24 hrs |
| Silica fume, ppb | 5 | 10.00 | |
| CaCl₂, ppb | | 29.60 | |
| Water, ppb | 5 | 85.30 | |
| BAROID ®, ppb | 10 | 222.20 | |
| Hot rolled at 250° F.,16 hrs | | | |
| 600 rpm | @120° F. | 31 | |
| 300 rpm | @120° F. | 15 | |
| 200 rpm | @120° F. | 10 | |
| 100 rpm | @120° F. | 6 | |
| 6 rpm | @120° F. | 1 | |
| 3 rpm | @120° F. | 1 | |
| PV | @120° F. | 16 | |
| YP | @120° F. | 1 | |
| LSYP | @120° F. | 1 | |
| GELS 10 sec | @120° F. | 2 | |
| GELS 10 min | @120° F. | 2 | |
| Sag factor | | | 0.69 |
| Oil separation | | | 10 cm/110 ml |

TABLE 3

| | Mixing | | | |
|---|---|---|---|---|
| | time, min | 5 | | |
| ESCAID ® 110, bbl | | 147.00 | Fluid 5 | Fluid 5 |
| EZ MUL ® NT, ppb | 2 | 10.00 | was | was |
| Lime, ppb | 2 | 1.50 | static aged | static aged |
| RHEMOD ™ L, ppb | 5 | 3.00 | @ 300° F. | @ 150° F. |
| ADAPTA ®, ppb | 5 | 2.00 | 24 hrs | 120 hrs |
| AEROSIL ® 380, ppb | 5 | 10.00 | | |
| CaCl₂, ppb | | 29.30 | | |
| Water, ppb | 5 | 83.53 | | |
| BAROID ®, ppb | 10 | 214.96 | | |
| BDF 570 ™, ppb | 5 | 3.00 | | |
| Hot rolled at 300° F., 16 hrs | | | | |
| 600 rpm | @120° F. | 86 | 99 | |
| 300 rpm | @120° F. | 58 | 68 | |
| 200 rpm | @120° F. | 45 | 54 | |
| 100 rpm | @120° F. | 31 | 38 | |
| 6 rpm | @120° F. | 9 | 11 | |
| 3 rpm | @120° F. | 7 | 9 | |
| PV | @120° F. | 28 | 31 | |
| YP | @120° F. | 30 | 37 | |
| LSYP | @120° F. | 5 | 7 | |
| GELS 10 sec | @120° F. | 8 | 10 | |
| GELS 10 min | @120° F. | 34 | 28 | |
| HTHP, ml/30 min | | 4.0 | | |
| (250° F.) | | | | |
| Sag factor | | | 0.52 | 0.507 |
| Oil separation | | | 0.5 cm/4 ml | 2 ml |

These measurements indicate that Fluid 1 in Table 1, formulated without fumed silica but with a primary modified fatty acid viscosifier, allowed barite settling, with a sag factor of 0.68 and oil separation of 8 cm corresponding to 100 ml. Fluid 2 in Table 1, formulated with fumed silica instead of the primary viscosifier also allowed barite settling, with a sag factor of 0.68 and oil separation of 7 cm corresponding to 100 ml. Fluid 3 in Table 1, an example formulation of the invert emulsion drilling fluids of this disclosure, with both a primary viscosifier and fumed silica, was stable, did not indicate barite settling, and had a sag factor of 0.5 with negligible oil separation of 0.2 cm. When this fluid was further static aged at 150° F. for 120 hours, the sag factor was still 0.50 with oil separation of 0.2 cm. When a similar invert emulsion drilling fluid was formulated according to the disclosure, Fluid 1 in Table 3, was hot rolled at 300° F. and then static aged at 300° F. for 24 hours, the measurements as shown in Table 3 indicated that the fluid was stable, without significant barite sag, with a sag factor of 0.52 and oil separation of 0.5 cm. When this fluid was further mixed on a multimixer for 5 minutes and static aged at 150° F. for 120 hours, the fluid gave an oil separation of 0.2 cm with a sag factor of 0.507.

The fluid formulation shown in Table 2 is generally like that of the invert emulsion drilling fluids of the disclosure, except that it uses silica fume, having a lower surface area than fumed silica, instead of fumed silica. This formulation with silica fume resulted in barite settling, with a SAG factor of 0.68 and an oil separation of 7 cm, indicating the importance of the size and surface area of the fumed silica in the effectiveness of the fumed silica in preventing barite sag.

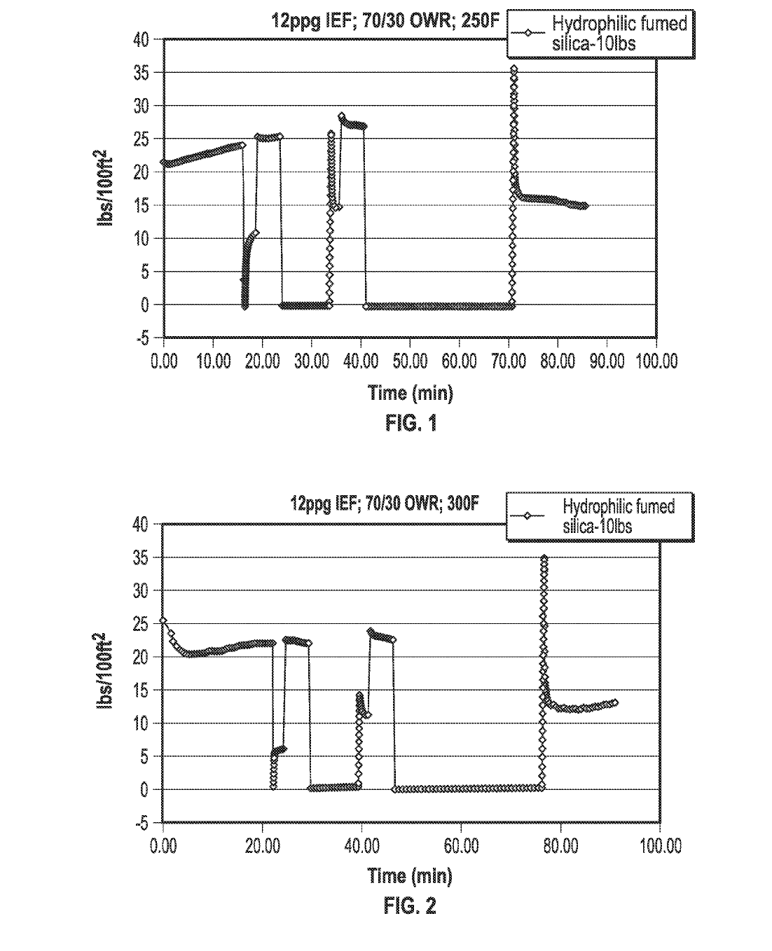

The Brookfield measurements reported in Table 3 were taken to determine the presence of fragile gels in example invert emulsion drilling fluids formulated according to the disclosure—Fluid 3 in Table 1 and Fluid 1 in Table 3. The measurements showed that the gel strengths were progressive as tested on a FANN 35 rheometer, but these gels were observed to be fragile as shown in FIGS. 1 and 2 respectively. The fragile gel peak heights were approximately 20 in both of these invert emulsion fluids of the disclosure. A peak height greater than 5 is considered good.

The measurements shown in the tables above indicate that the invert emulsion drilling fluids of the disclosure provide stable invert emulsions and have good rheological properties for drilling. Moreover, the invert emulsion drilling fluids of the disclosure are able to provide good sag control, that is, the fluids of the disclosure avoid a tendency toward barite sag after aging, while still maintaining good fragile gel properties characteristic of “clay-free” invert emulsion drilling fluids. The invert emulsion drilling fluids of the disclosure thus not only help resolve issues related to barite sag without the addition of organophilic clays or lignites or “low gravity solids,” but also minimize surge and swab pressures while tripping in and out of the borehole. Fumed silica used in the invert emulsion drilling fluids of the disclosure has low gravity and is a solid and in this sense is also a low gravity solid. However, the term “low gravity solids” as used herein, and as defined previously herein, refers to “low gravity solids” in the traditional sense and common manner used by the oil and gas industry and does not include fumed silica.

As indicated above, the advantages of the methods of the disclosure may be obtained by employing invert emulsion drilling fluids of the disclosure in drilling operations. The drilling operations—such as, drilling a vertical, directional or horizontal borehole, conducting a sweep, or running casing and cementing—may be conducted as known to those skilled in the art with other drilling fluids. That is, a drilling fluid of the disclosure is prepared or obtained and circulated through a wellbore as the wellbore is being drilled (or swept or cemented and cased) to facilitate the drilling operation. The drilling fluid removes drill cuttings from the wellbore, cools and lubricates the drill hit, aids in support of the drill pipe and drill bit, and provides a hydrostatic head to maintain the integrity of the wellbore walls and prevent well blowouts. The specific formulation of the drilling fluid in accordance with the present disclosure is optimized for the particular drilling operation and for the particular subterranean formation characteristics and conditions (such as temperatures). For example, the fluid is weighted as appropriate for the formation pressures and thinned as appropriate for the formation temperatures. As with other “clayfree” drilling fluids, the fluids of the disclosure afford real-time monitoring and rapid adjustment of the fluid to accommodate changes in such subterranean formation conditions. Further, the fluids of the disclosure may be recycled during a drilling operation such that fluids circulated in a wellbore may be recirculated in the wellbore after returning to the surface for removal of drill cuttings for example. The drilling fluid of the disclosure may even be selected for use in a drilling operation to reduce loss of drilling mud during the drilling operation and/or to comply with environmental regulations governing drilling operations in a particular subterranean formation.

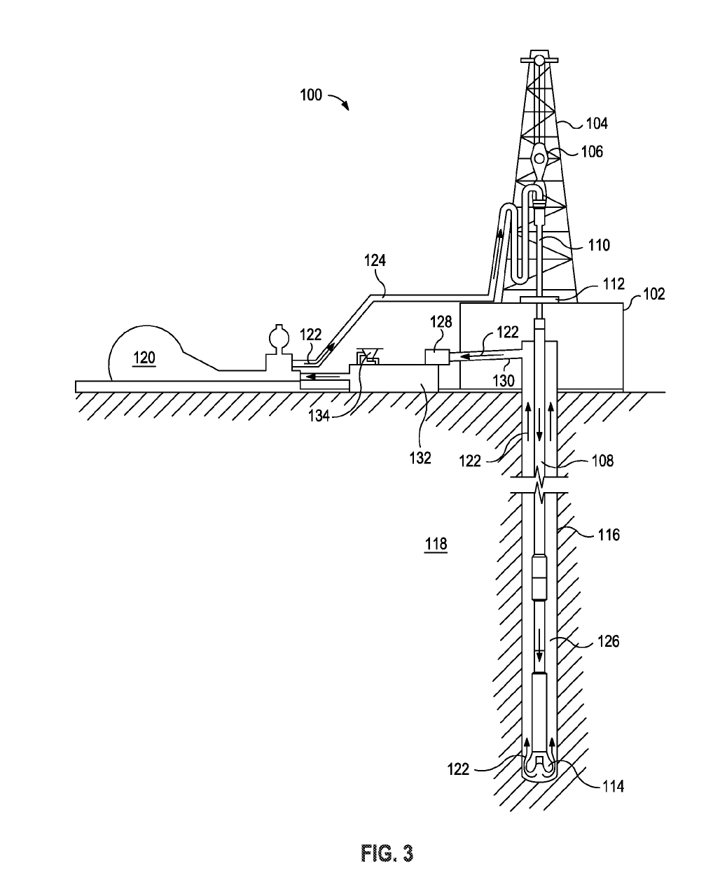

The exemplary suspension agent (drilling fluid additives) disclosed herein may directly or indirectly affect one or more components or pieces of equipment associated with the preparation, delivery, recapture, recycling, reuse, and/or disposal of the disclosed additives. For example, and with reference to FIG. 3, the disclosed additives may directly or indirectly affect one or more components or pieces of equipment associated with an exemplary wellbore drilling assembly 100, according to one or more embodiments. It should be noted that while FIG. 3 generally depicts a land-based drilling assembly, those skilled in the art will readily recognize that the principles described herein are equally applicable to subsea drilling operations that employ floating or sea-based platforms and rigs, without departing from the scope of the disclosure.

As illustrated, the drilling assembly 100 may include a drilling platform 102 that supports a derrick 104 having a traveling block 106 for raising and lowering a drill string 108. The drill string 108 may include, but is not limited to, drill pipe and coiled tubing, as generally known to those skilled in the art. A kelly 110 supports the drill string 108 as it is lowered through a rotary table 112. A drill bit 114 is attached to the distal end of the drill string 108 and is driven either by a downhole motor and/or via rotation of the drill string 108 from the well surface. As the bit 114 rotates, it creates a borehole 116 that penetrates various subterranean formations 118.

A pump 120 (e.g., a mud pump) circulates drilling fluid 122 through a feed pipe 124 and to the kelly 110, which conveys the drilling fluid 122 downhole through the interior of the drill string 108 and through one or more orifices in the drill bit 114. The drilling fluid 122 is then circulated back to the surface via an annulus 126 defined between the drill string 108 and the walls of the borehole 116. At the surface, the recirculated or spent drilling fluid 122 exits the annulus 126 and may be conveyed to one or more fluid processing unit(s) 128 via an interconnecting flow line 130. After passing through the fluid processing unit(s) 128, a “cleaned” drilling fluid 122 is deposited into a nearby retention pit 132 (i.e., a mud pit). While illustrated as being arranged at the outlet of the wellbore 116 via the annulus 126, those skilled in the art will readily appreciate that the fluid processing unit(s) 128 may be arranged at any other location in the drilling assembly 100 to facilitate its proper function, without departing from the scope of the scope of the disclosure.

One or more of the disclosed additives may be added to the drilling fluid 122 via a mixing hopper 134 communicably coupled to or otherwise in fluid communication with the retention pit 132. The mixing hopper 134 may include, but is not limited to, mixers and related mixing equipment known to those skilled in the art. In other embodiments, however, the disclosed additives may be added to the drilling fluid 122 at any other location in the drilling assembly 100. In at least one embodiment, for example, there could be more than one retention pit 132, such as multiple retention pits 132 in series. Moreover, the retention pit 132 may be representative of one or more fluid storage facilities and/or units where the disclosed additives may be stored, reconditioned, and/or regulated until added to the drilling fluid 122.

As mentioned above, the disclosed additives may directly or indirectly affect the components and equipment of the drilling assembly 100. For example, the disclosed additives may directly or indirectly affect the fluid processing unit(s) 128 which may include, but is not limited to, one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, any fluid reclamation equipment, The fluid processing unit(s) 128 may further include one or more sensors, gauges, pumps, compressors, and the like used store, monitor, regulate, and/or recondition the exemplary additives.

The disclosed additives may directly or indirectly affect the pump 120, which representatively includes any conduits, pipelines, trucks, tubulars, and/or pipes used to fluidically convey the additives downhole, any pumps, compressors, or motors (e.g., topside or downhole) used to drive the additives into motion, any valves or related joints used to regulate the pressure or flow rate of the additives, and any sensors (i.e., pressure, temperature, flow rate, etc.), gauges, and/or combinations thereof, and the like. The disclosed additives may also directly or indirectly affect the mixing hopper 134 and the retention pit 132 and their assorted variations.

The disclosed additives may also directly or indirectly affect the various downhole equipment and tools that may come into contact with the additives such as, but not limited to, the drill string 108, any floats, drill collars, mud motors, downhole motors and/or pumps associated with the drill string 108, and any MWD/LWD tools and related telemetry equipment, sensors or distributed sensors associated with the drill string 108. The disclosed additives may also directly or indirectly affect any downhole heat exchangers, valves and corresponding actuation devices, tool seals, packers and other wellbore isolation devices or components, and the like associated with the wellbore 116. The disclosed additives may also directly or indirectly affect the drill bit 114, which may include, but is not limited to, roller cone bits, PDC bits, natural diamond bits, any hole openers, reamers, coring bits, etc.

While not specifically illustrated herein, the disclosed additives may also directly or indirectly affect any transport or delivery equipment used to convey the additives to the drilling assembly 100 such as, for example, any transport vessels, conduits, pipelines, trucks, tubulars, and/or pipes used to fluidically move the additives from one location to another, any pumps, compressors, or motors used to drive the additives into motion, any valves or related joints used to regulate the pressure or flow rate of the additives, and any sensors (i.e., pressure and temperature), gauges, and/or combinations thereof, and the like.

The foregoing description of the disclosure is intended to be a description of some embodiments. Various changes in the details of the described fluids and methods of use can be made without departing from the intended scope of this disclosure as defined by the appended claims.

What is claimed is:

1. An invert emulsion drilling fluid for drilling in a subterranean formation comprising:
an oleaginous continuous phase;
an aqueous internal phase; and
a suspension agent comprising very fine sized fumed silica in combination with a primary viscosifier.

2. The drilling fluid of claim 1 wherein the fluid is substantially free of additives comprising non-hydrophilic low gravity solids.

3. The drilling fluid of claim 2 wherein the non-hydrophilic low gravity solids consist of sized calcium carbonate, ground marble, zeogel, bentonite, attapulgite, and other organophilic clay materials.

4. The drilling fluid of claim 1 wherein the fluid is substantially free of organophilic clays and lignites.

5. The drilling fluid of claim 1 wherein the base oil is selected from the group consisting of: paraffins; mineral oils; desulfurized hydrogenated kerosenes; diesel, esters, and combinations thereof.

6. The drilling fluid of claim 1 wherein the very fine sized fumed silica has a specific surface area in the range of 90 m²/gm to 700 m²/gm.

7. The drilling fluid of claim 1 wherein the fluid has a barite sag factor of less than about 0.53 after hot rolling at 250° F.

8. The drilling fluid of claim 1 wherein the very fine sized fumed silica comprises a combination of two different grades, one having an average particle size of 7 nm and the other having an average particle size of 0.1 to 0.3 μm.

9. The drilling fluid of claim 1 wherein the primary viscosifier is selected from the group consisting of dimer diamines, fatty dimer diamines, dimer fatty acids, pentaerythirtol tetrastearate and combinations thereof.

9. The drilling fluid of claim 1 wherein the ratio of primary viscosifier to fumed silica is about 1:5.

10. The drilling fluid of claim 1 wherein the quantity of primary viscosifier ranges from about 0.5 ppb to about 3.0 ppb and the quantity of fumed silica ranges from 0.5 ppb to about 15 ppb.

11. The drilling fluid of claim 1 wherein the primary viscosifier has about 28 to about 48 carbon atoms.

12. The drilling fluid of claim 1 wherein the primary viscosifier has about 36 carbon atoms.

13. The drilling fluid of claim 1 wherein the fumed silica has an average specific surface area of about 380 m²/gm or an average particle size of about 7 μm.

14. The drilling fluid of claim 1 wherein the fumed silica is hydrophilic.

15. A method for drilling in a subterranean formation having shales comprising:
providing or using an invert emulsion drilling fluid having:
a base oil;
an internal aqueous phase; and
a suspension agent comprising a combination of a primary viscosifier and very fine sized fumed silica; and
drilling through shales in the subterranean formation with the drilling fluid.

16. The method of claim 15 wherein the drilling fluid contains substantially no organophilic clays or lignites and no non-hydrophilic low gravity solids.

17. The method of claim 15 wherein the base oil of the drilling fluid is selected from the group of oils consisting of paraffins, mineral oils, kerosene, and combinations thereof.

18. The method of claim 15 wherein the primary viscosifier of the drilling fluid is selected from the group consisting of dimer diamines, fatty dimer diamines, dimer fatty acids, and pentaerythirtol tetrastearate.

19. The method of claim 15 wherein the very fine sized fumed silica of the drilling fluid has a specific surface area in the range of in the range of 90 m²/gm to 700 m²/gm.

20. The method of claim 15 wherein the drilling fluid has a barite sag factor of less than about 0.53 after hot rolling at 250° F.
